(19) United States
(12) Patent Application Publication
(10) Pub. No.: US 2006/0119729 A1
(43) Pub. Date: Jun. 8, 2006

(54) Image-capture apparatus

(75) Inventor: Ming-Kuan Qian, Tai-Zhou City (TW)

Correspondence Address: REED SMITH LLP, Suite 1400, 3110 Fairview Park Drive, Falls Church, VA, 22042, US

(73) Assignee: BenQ Corporation

(21) Appl. No.: 11/294,469

(22) Filed: Dec. 6, 2005

(30) Foreign Application Priority Data
Dec. 6, 2004 (TW) 93137624

(51) Int. Cl. H04N 5/225

(52) U.S. Cl. 348/340

(57) ABSTRACT

An image capture apparatus includes a contact window, an image sensor image sensor module, a carriage, a guiding shaft, a first resilient element and a second resilient element. The first resilient element is disposed between the guiding shaft and the carriage. The first resilient element provides a first force to make the image sensor module keep close to the contact window. The second resilient element is disposed between the image sensor module and the carriage. The second resilient element provides a second force to keep the relative position between the image sensor module and the carriage substantially unchanged during operation.

### FIELD OF THE INVENTION

This invention relates to an image capture apparatus, and more particularly, to an image capture apparatus including a resilient element.

### BACKGROUND OF THE INVENTION

An image capture apparatus equipped with a image sensor is a well-known peripheral device to computers. The image capture apparatus is utilized to scan documents or pictures to transform the original data into a digital format, allowing further editing/processing by applications.

An image capture device typically includes a light source, focusing lens, an image sensor module and a carriage. For some kind of image sensors, their focusing range is relatively short (for example, about 0.3 mm), and how to keep the image sensor module and the window glass at the same position during image capture process is one of the many concerns in design stage.

As shown in FIG. 1, the image capture apparatus includes a window glass 101, a smooth element 103, an image sensor module 105, a carriage 107, a guiding shaft 109, a guiding element 111 and a first resilient element 113. The guiding shaft 109 provides the first resilient element 113 with a support force via the guiding element 111, and the first resilient element 113 provides a force upward, to maintain the distance between the image sensor module 105 and the smooth element 103 and the distance between the smooth element 103 and the window glass 101 keeping unchanged, to facilitate the scanning operations.

In conventional ways, the resilient element, which is disposed between the guiding shaft and the image sensor module, provides a force to keep the distance between the image sensor module and the window glass unchanged. The disadvantage of those kinds of designs is, for example, lacking of mechanism for controlling the stability of the image sensor module and the carriage during operation, which adversely affects the scanning quality.

### SUMMARY OF THE INVENTION

An image capture apparatus is provided. The apparatus includes a contact window, an image sensor module, a carriage, a guiding shaft, a first resilient element and a second resilient element. The first resilient element is disposed between the guiding shaft and the carriage. The first resilient element provides a first force to make the image sensor module keep close to the contact window. The second resilient element is disposed between the image sensor module and the carriage. The second resilient element provides a second force to keep the image sensor module and the carriage stable during operation.

The image sensor module provided in the present invention includes a first portion, and the carriage provided in the present invention includes a second portion. The second resilient element is connected with the first portion and the second portion respectively.

The image capture apparatus of the present invention also includes a smooth element disposed between the image sensor module and the window glass to reduce a friction between the image sensor module and the window glass.

### BRIEF DESCRIPTION OF THE DRAWINGS

FIG. 1 is a profile illustrating an image capture apparatus of prior art.

FIG. 2a is a profile illustrating an embodiment of the present invention.

FIG. 2b is a schematic view illustrating an embodiment of the present invention.

FIG. 3 is a schematic view illustrating another embodiment of the present invention.

FIG. 4 is a schematic view illustrating details of the embodiment shown in FIG. 3.

FIG. 5 is a schematic view illustrating details of the embodiment shown in FIG. 3.

FIG. 6 is a schematic view illustrating another embodiment of the present invention.

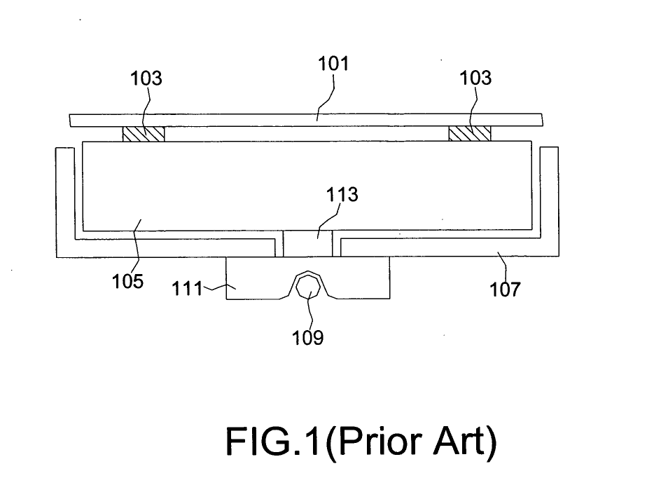

### DETAILED DESCRIPTION OF THE INVENTION

An image capture apparatus is provided. The apparatus includes a contact window, an image sensor module, a carriage, a guiding shaft, a first resilient element and a second resilient element. The first resilient element is disposed between the guiding shaft and the carriage. The first resilient element provides a first force to make the image sensor module keep close to the contact window. The second resilient element is disposed between the image sensor module and the carriage. The second resilient element provides a second force to keep the image sensor module and the carriage stable during operation. The term “stable” described here means that there is not any undetermined movement (for example, vibrations) caused, thus the image sensor module and the carriage can move along the predetermined direction smoothly.

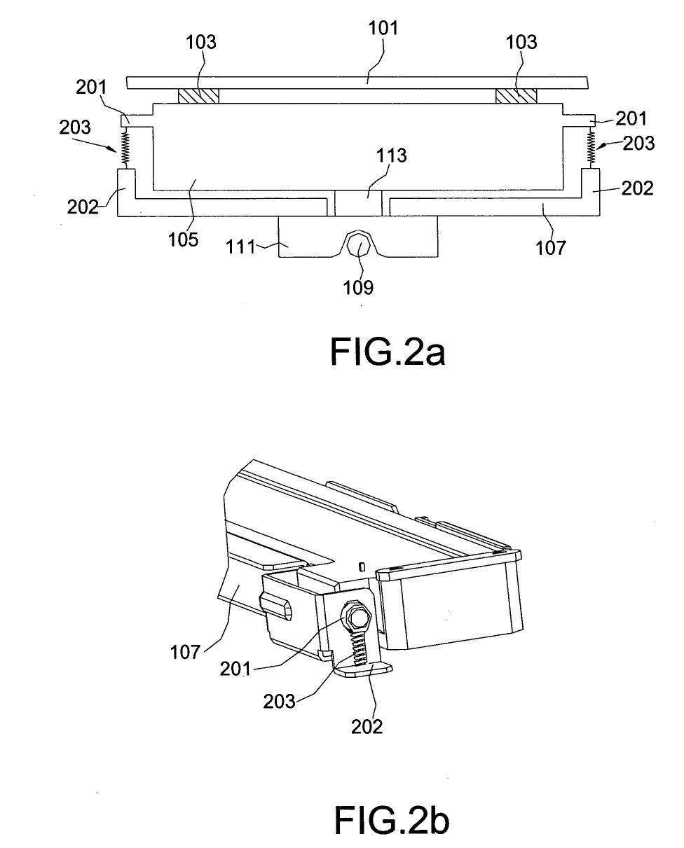

FIG. 2a is a profile of one embodiment of the present invention, and FIG. 2b is a schematic view of the same embodiment of the present invention in FIG. 2a. Referring to FIGS. 2a and 2b, the image capture apparatus includes a window glass 101, a smooth element 103, an image sensor module 105, a carriage 107, a guiding shaft 109, a guiding element 111, a first resilient element 113 and the second resilient element 203. The window glass is provided for supporting the objects to be scanned. The smooth element 103 is disposed between the image sensor module 105 and the window glass 101, to reduce the friction between the image sensor module 105 and the window glass 101. The carriage 107 is provided for supporting the image sensor module 105, and the guiding shaft 109 disposed under the carriage 107 is for guiding the carriage to move. The guiding element 111 provides a force to keep the relative position between the image sensor module 105 and the window glass 101 unchanged. The first resilient element 113 disposed between the guiding shaft 109 and the carriage 107 provides a first force to keep the image sensor module and the window glass substantially close to each other. The second resilient element 203 disposed between the image sensor module and the carriage 107 provides a second force to keep the image sensor module 105 and the carriage 107 stable during operation.

As shown in FIG. 2a, the image sensor module includes a first portion 201 and the carriage 107 includes a second portion 202. The second resilient element is connected with the first portion 201 and the second portion 202 respectively.

As shown in FIGS. 2a and 2b, the guiding shaft 109 provides an upward supporting force to the first resilient element 113 via the guiding element 111, and the first resilient element 113 further provides the image sensor module with a first force (upward), to keep the relative position between the image sensor module 105, smooth element 103 and the window glass 101 remaining unchanged during scanning process. The second resilient element 203 is connected with the first portion 201 of the image sensor module 105 and the second portion 202 of the carriage 107, respectively. Thus the second resilient element 203 provides a second force (in this embodiment, a tension is applied to the second resilient element 203) to keep the image sensor module 105 and the carriage 107 stable during operation.

In the embodiment described in FIGS. 2s and 2b, the second resilient element 203 is disposed at the two sides of the image sensor module 105. In other embodiments, however, it can only be disposed only at one side. Although the first portion 201 and the second portion 202 are protrusions in this embodiment, and in other embodiments, however, they can be other devices with the similar function, for instance, a latch device.

In the embodiment described in FIGS. 2s and 2b, the second force is a tension. In other embodiments, however, the second force can be a compression force, and it depends to the design and the user's need. The guiding element 111 also can include a torsion spring, to provide a force to keep the relative position between the image sensor module 105 and the window glass 101 remaining unchanged.

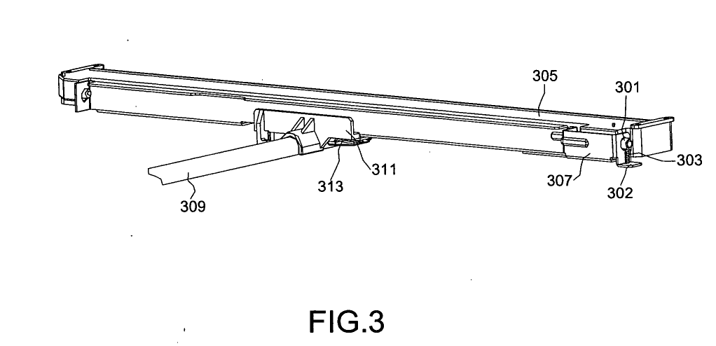

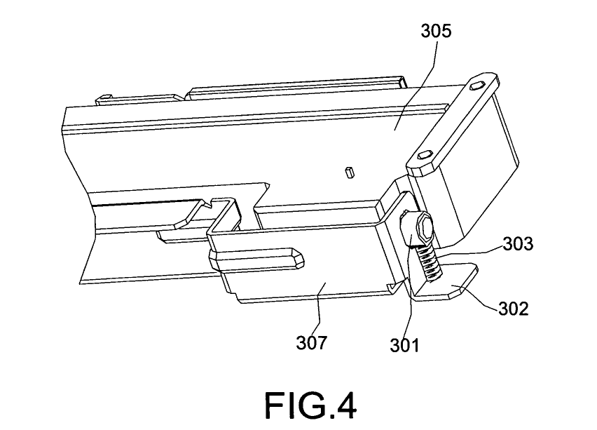

FIG. 3 is a schematic view of another embodiment of the present invention. As shown in FIG. 3, the carriage 307 is disposed on the guiding element 311 (the first resilient element 313 is disposed between the guiding element 311 and the image sensor module, and only part of the first resilient element 313 is shown in FIG. 3) and the carriage 307 supports the image sensor module 305. When processing the scanning, the image sensor module 305 moves along the guiding shaft 309 to facilitate the scanning. The second resilient element 303 is connected with the first portion 301 of the image sensor module 305 and the second portion 302 of the carriage 307. The second resilient element 303 provides a second force (In this embodiment, a compression force is applied to the second resilient element 303) to keep the relative position between the image sensor module 305 and the carriage 307 during operation. FIG. 4 is a schematic view illustrating details of the embodiment shown in FIG. 3. As shown in FIG. 4, the first portion 301 here is a circular ring, and the second resilient element 303 (In this embodiment, the second resilient element 303 is a spring) is connected with the first portion 301. Thus, the second resilient element provides the multi-directional second force to keep the relative position between the image sensor module 305 and the carriage 307 unchanged.

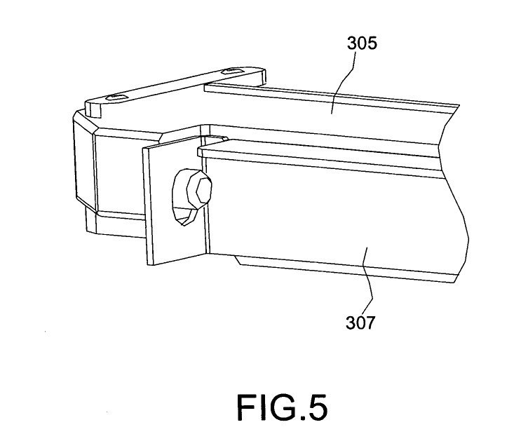

FIG. 5 is a schematic view illustrating details of the embodiment shown in FIG. 3. As shown in FIG. 5, the second resilient element 303 can only be disposed at one side of the image sensor module, while in other embodiments, the second resilient element 303 can be disposed at two sides of the image sensor module, for better stability.

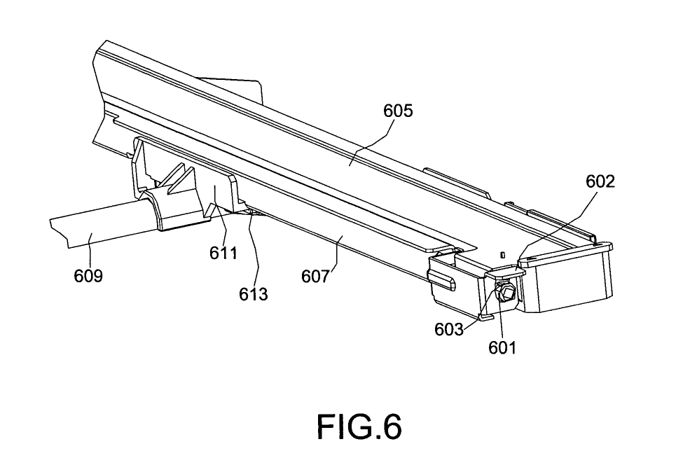

FIG. 6 is a schematic view illustrating another embodiment of the present invention. In the embodiment of FIG. 6. In the embodiment of FIG. 6, the carriage 607 is disposed on the guiding element 611 (the first resilient element 613 is disposed between the guiding element 611 and the image sensor module, and only part of the first resilient element 613 is shown in FIG. 6) and the carriage 607 supports the image sensor module 605. When processing the scanning, the image sensor module 605 moves along the guiding shaft 609 to facilitate the scanning. The second resilient element 603 is connected with the first portion 601 of the image sensor module 605 and the second portion 602 of the carriage 607. The second resilient element 603 provides a second force (In this embodiment, a compression force is applied to the second resilient element 603) to keep the relative position between the image sensor module 605 and the carriage 607 during operation. Similar to the embodiment described in FIG. 3, the resilient elements in FIG. 6 can also be disposed at the two sides of the image sensor module to enhance the stability during operation.

While the invention has been described in connection with what is presently considered to be the most practical and preferred embodiments, it is to be understood that the invention is not to be limited to these embodiments. The invention is intended to cover various modifications and equivalent arrangements within the spirit and scope of the appended claims.

1. An image capture apparatus, comprising:
a window glass;
a image sensor image sensor module disposed under the window glass;
a carriage for supporting the image sensor module;
a guiding shaft disposed under the carriage for guiding movement of the carriage;
a first resilient element disposed between the guiding shaft and the carriage, the first resilient element providing a first force to make the image sensor module substantially close to the window glass; and
a second resilient element disposed between the image sensor module and the carriage, the second resilient element providing a second force between the image sensor module and the carriage.

2. The apparatus according to claim 1, wherein the image sensor module includes a first portion, and the carriage includes a second portion, and the second resilient element is connected with the first portion and the second portion respectively.

3. The apparatus according to claim 2, wherein the first portion is disposed at two sides of the image sensor module.

4. The apparatus according to claim 2, wherein the second portion is disposed at two sides of the carriage.

5. The apparatus according to claim 2, wherein the first portion includes a protrusion.

6. The apparatus according to claim 1, wherein a tension force is applied to the second resilient element.

7. The apparatus according to claim 1, wherein a compression force is applied to the second resilient element.

8. The apparatus according to claim 1, further comprising a smooth element disposed between the image sensor module and the window glass to reduce friction between the image sensor module and the window glass.

9. The apparatus according to claim 8, further comprising a guiding element providing a force to keep the relative position between the image sensor module and the window glass substantially unchanged.

10. The apparatus according to claim 9, wherein the guiding element includes a torsion spring.

11. An image capture apparatus, comprising:
a window glass;
a image sensor image sensor module disposed under the window glass, the image sensor module including a first portion;
a carriage for supporting the image sensor module, the carriage including a second portion;
a guiding shaft disposed under the carriage for guiding movement of the carriage;
a first resilient element disposed between the guiding shaft and the carriage, the first resilient element providing a first force to make the image sensor module substantially close to the window glass; and
a second resilient element disposed between the first portion of the image sensor module and the second portion of the carriage, the second resilient element providing a second force between the image sensor module and the carriage.

12. The apparatus according to claim 11, wherein the first portion is disposed at two sides of the image sensor module.

13. The apparatus according to claim 11, wherein the second portion is disposed at two sides of the carriage.

14. The apparatus according to claim 11, wherein the first portion includes a protrusion.

15. The apparatus according to claim 11, wherein a tension force is applied to the second resilient element.

16. The apparatus according to claim 11, wherein a compression force is applied to the second resilient element.

17. The apparatus according to claim 11, further comprising a smooth element disposed between the image sensor module and the window glass to reduce friction between the image sensor module and the window glass.

18. The apparatus according to claim 17, further comprising a guiding element providing a force to keep the relative position between of the image sensor module and the window glass substantially unchanged.

19. The apparatus according to claim 18, wherein the guiding element includes a torsion spring.
